(19) United States
(12) Patent Application Publication
(10) Pub. No.: US 2026/0298730 A1
(43) Pub. Date: Oct. 1, 2026

(54) AN APPARATUS AND A METHOD FOR DETERMING THE TEMPERATURE OF FLUIDS CONTAINED IN A PIPE OR A VESSEL

(71) Applicant: CLAMPON AS, Laksevåg (NO)

(72) Inventors: Audun OPPEDAL PEDERSEN, Nesttun (NO); Geir INSTANES, Nesttun (NO); Kjetil NYSÆTER, Kalandseidet (NO)

(21) Appl. No.: 19/476,841

(22) PCT Filed: Apr. 22, 2024
(86) PCT No.: PCT/NO2024/000002

§ 371 Date: Oct. 20, 2025

(30) Foreign Application Priority Data
Apr. 21, 2023 (NO) 20230433

(51) Int. Cl. G01K 13/02; G01K 1/02; G01K 1/14

(52) U.S. Cl. CPC G01K 13/02; G01K 1/026; G01K 1/14

(57) ABSTRACT

A temperature determining apparatus and a method for determining the temperature of fluids contained in a pipe or vessel is disclosed. The temperature determining apparatus has an exterior wall surface and comprises at least two temperature sensing elements which are signally connected to a control unit for reading and processing signals received from the at least two temperature sensing elements. The temperature determining apparatus further comprises an attachment device for attachment or mounting of the temperature determining apparatus to the exterior wall surface of the pipe or vessel, and a thermally insulating body which is adapted to be in contact with the exterior wall surface of the pipe or vessel when the temperature determining apparatus is attached or mounted to the pipe or vessel. At least one first temperature sensing element is arranged such that it is capable of sensing the temperature of the exterior wall surface covered by the thermally insulating body when the temperature determining apparatus is attached or mounted to the exterior wall surface of the pipe or vessel. The temperature determining apparatus further comprises at least one third temperature sensing element which is arranged to sense the temperature of the free exterior wall surface of the pipe or vessel.

### CROSS-REFERENCE TO RELATED APPLICATION(S)

This is a national stage application filed under 37 U.S.C. 371 based on International Patent Application No. PCT/NO2024/000002, filed Apr. 22, 2024, which claims priority to Norwegian patent application No. 20230433, filed Apr. 21, 2023, the entire contents of which are incorporated herein by reference in their entirety.

### TECHNICAL FIELD

The invention relates to an apparatus and a method for determining the temperature of fluids contained in a pipe or vessel from the outside of the pipe or vessel, without penetrating or otherwise making changes to the wall of the pipe or vessel.

### BACKGROUND ART

Accurate measurement of the temperature of a fluid typically requires a construction containing a temperature sensing element, that penetrates a wall of a pipe, or a vessel containing the fluid and protrudes a distance into the fluid where the temperature is measured. This is undesirable in many applications since any wall penetration constitutes a possible leak point with associated risk and need for inspection and maintenance. Furthermore, temperature sensors cannot be installed on new locations while the pipe or vessel is in service and containing fluid.

Methods for measuring the temperature of exterior wall surfaces, sometimes referred to as skin temperature, are known. One example is the Korean patent KR 101815273 B1 which discloses an apparatus for measuring the exterior surface temperature of a pipe containing a fluid with high temperature. Another example is the U.S. Pat. No. 11,248,940 B2 which discloses a system and method where exterior surface temperature measurements are used to identify a fluid flow condition inside a pipe.

Additional prior art can be found in the published patent publications US 2020/096394 A1, WO 2013/132239 A2, US 2008/163692 A1 and US 2023/030690 A1.

U.S. Pat. No. 9,360,377B2 describes a temperature determining apparatus for determining the temperature of fluids contained in a pipe or vessel having an exterior wall surface, the temperature determining apparatus comprising two temperature sensing elements which are signally connected to a control unit for reading and processing signals received from the two temperature sensing elements, the temperature determining apparatus further comprising an attachment device for attachment or mounting of the temperature determining apparatus to the exterior wall surface of the pipe or vessel.

The exterior wall surface temperature alone can indicate approximately the temperature of the fluid inside a pipe or vessel but is strongly affected by other factors such as the temperature of the surroundings and the thermally insulating effect of the wall. Particularly, when the pipe or vessel is submerged in water, such as on the seafloor, the exterior wall surface temperature can be very close to that of the surrounding water and correlate only weakly with the temperature of the fluid inside the pipe or vessel.

### BRIEF SUMMARY OF THE INVENTION

Thus, the object of the present invention has been to obtain a non-intrusive measurement, by fixed or mobile apparatus, of the temperature of fluids contained in vessels and pipes, including, but not limited to, vessels and pipes submerged in water.

This object is met by a temperature determining apparatus for determining the temperature of fluids contained in a pipe or vessel as defined in claim 1 and a method for determining the temperature of fluids contained in a pipe or vessel surrounded by a surrounding medium as defined in claim 12. The dependent claims define alternative embodiments of the present invention.

### DESCRIPTION OF THE INVENTION

Thus, the invention comprises a temperature determining apparatus and a method for determining the temperature of a fluid contained inside a pipe or vessel, where the temperature determining apparatus is affixed non-intrusively to the exterior wall surface of the pipe or vessel, without any modification to the wall such as by drilling or welding.

Applications of the present invention include, but are not limited to, continuous monitoring at permanent locations and thermal inspection at multiple locations, for example along the length of a pipeline.

A central application for the non-intrusive fluid temperature measurement made possible by the present invention is flow assurance and asset management, such as, for example, managing oil viscosity, phase transitions, and hydrate formation in gas pipelines. The needs for fluid temperature measurements can change through the lifetime of an industrial plant. Examples of situations with different temperature monitoring and inspection needs are (1) upon commissioning of a gas flow line, where temperatures in the pipeline should be investigated upon start-up, normal flow, and shut-in, (2) as pressures and flow rates in pipes connecting to a petroleum well evolve through the lifetime of the well, and (3) when compressors are installed on the seafloor to extend the lifetime of a petroleum well.

The temperature determining apparatus can be affixed to an exterior wall surface by means of an attachment device, such as for example one or more magnets that are incorporated in the temperature determining apparatus. The wall material used in fluid containing pipe or vessel materials is however not always magnetic. Thus, the attachment device may comprise a mechanic clamping mechanism that can be used to affix the temperature determining apparatus to the exterior wall surface of a pipe. Furthermore, depending on the application, the attachment device may comprise an adhesive or a suction arrangement that can be used to affix the temperature determining apparatus to the exterior wall surface of a vessel that is too large for a clamping mechanism to be used.

The temperature determining apparatus includes at least one, but preferably a plurality of temperature sensing elements and a thermally insulating body covering a portion of the exterior surface of the wall of the pipe or vessel. At least one of the temperature sensing elements is positioned on the exterior wall surface of the pipe or vessel, i.e., the contact surface between the wall and the thermally insulating body.

Optionally, temperature sensing elements may be positioned in the surrounding atmosphere or for example seawater, away from the wall surface, to measure the ambient temperature. Other optional temperature sensing elements can be positioned on the exterior wall surface of the pipe or vessel, away from the thermally insulating body, to measure the surface temperature of the surface of the pipe or vessel without insulation.

The temperature sensing elements are connected to a control unit that reads the measured temperatures, transforms them to digital information, and processes and stores the results. The measurement results may optionally be transferred to a client system connected to the control unit.

The temperature determining apparatus further comprises a mechanical structure that holds the said components in place and can be attached to the wall surface of the pipe or vessel by magnets, clamps, adhesion, suction, or other suitable means.

Three-dimensional heat calculations can be used in the design process for the thermally insulating body and the mechanical structure as well as for the positioning of the temperature sensing elements. The design ensures measurements that enable determination of the temperature of the fluid contained in the pipe or vessel, to sufficient accuracy for the intended application of the measurement result.

The three-dimensional heat calculations are based on classical thermal conduction as expressed by the Fourier heat formula. On differential form, the formula states that in any point within a thermally conductive medium,

$$\vec{Φ} = - κ \cdot ∇ T ,$$

where \vec{Φ} is the heat flux density vector, κ is the thermal conductivity of the medium, and ∇T is the local temperature gradient. The formula can be integrated numerically for three-dimensional geometries. For any position \vec{r} on the exterior wall surface, i.e. the contact surface between the pipe or vessel wall and the thermally insulating body, one can define effective thermal conductances U_{w}(\vec{r}) and Uᵢ(\vec{r}) of the wall and of the thermally insulating body, respectively, due to homogeneous ambient temperature T_{amb} of the surroundings outside the wall and insulating body, and homogeneous fluid temperature T_{flow} inside the pipe or vessel wall. Assuming homogeneous and slowly varying temperatures T_{amb} and T_{fluid} in the vicinity of the wall of the pipe or vessel and the temperature determining apparatus, all points on the contact surface between the wall and the temperature determining apparatus are at position-dependent equilibrium temperatures T_{surface}(\vec{r}) such that

$${T}_{f l u i d} = k ( \vec{r} ) {T}_{surface} ( \vec{r} ) - ( k ( \vec{r} ) - 1 ) {T}_{a m b}$$

where, to a first order of approximation, k(\vec{r}) is independent of the temperatures and can be calculated numerically from the three-dimensional geometry of the temperature determining apparatus and the wall of the pipe or vessel, given knowledge of the thermal conductivities of the wall material and the material of the thermally insulating body. The dimensions and shape of the thermally insulating body and the positions \vec{r}ₛₑₙₛ of one or more temperature sensing elements can be selected by sensitivity analysis of the numerically calculated k(\vec{r}), seeking high sensitivity to T_{fluid} and low sensitivity to T_{amb} and the thermal conductivity of the wall material. Rearrangement of the equation above also gives opportunity to determine k(\vec{r}ₛₑₙₛ) experimentally and compare the experimentally and theoretically determined values, as

$$k ( {\vec{r}}_{s e n s} ) = \frac{{T}_{fluid} - {T}_{a m b}}{{T}_{surface} ( {\vec{r}}_{s e n s} ) - {T}_{a m b}} .$$

An important aspect of the invention is that the thermally insulating body and mechanical structure are shaped so that the atmosphere or water surrounding the pipe or vessel is effectively expelled from the exterior wall surface, i.e. the contact surface between the thermally insulating body included in the temperature determining apparatus and the wall of the pipe or vessel, as part of the process where the temperature determining apparatus is affixed to the wall surface. This is of importance to ensure sufficient agreement with the calculation model and thus the required accuracy in the calculation of the temperature T_{fluid} of the fluid contained in the pipe or vessel.

The thermal conductance of the wall of the pipe or vessel can be estimated by combining measurements from multiple temperature sensing elements, providing knowledge of both T_{amb}, T_{surface}, and the free skin temperature T_{free} of the free exterior wall surface of the pipe or vessel where it is not covered by any thermally insulating material.

Alternatively, when the temperature of the fluid contained in the pipe or vessel is significantly different from the temperature in the surroundings, the thermal conductance of the wall can be estimated from the time evolution of the temperature Tₘ(\vec{r}ₛₑₙₛ,t) measured by one or more temperature sensing elements so positioned in the temperature determining apparatus that they will be at the exterior wall surface, i.e. the contact surface between the pipe or vessel wall and the thermally insulating body once the temperature determining apparatus has been attached/mounted to the wall. Such temperature sensing elements measure T_{amb} while the temperature determining apparatus is not attached/mounted to the wall of the pipe or vessel. Upon being brought in position on the wall surface at a time to, the measured temperature changes quickly towards the non-insulated exterior wall surface temperature T_{free}. The insulating material of the temperature determining apparatus causes the exterior wall surface temperature to change towards the fluid temperature, but more slowly than the said change of Tₘ(t) towards the pipe surface temperature. The resulting time evolution of the measured temperature is composed of an initial rapid exponential temperature change towards the exterior wall surface temperature, followed by a slower temperature change towards the equilibrium temperature T_{surface}(\vec{r}ₛₑₙₛ) of the exterior wall surface when insulated by the temperature determining apparatus. T_{free} can be estimated by identifying a “knee” in Tₘ(\vec{r}ₛₑₙₛ,t), for example detected as a local extremal point t₁(\vec{r}ₛₑₙₛ) of the curvature

$$γ ( t ) = \frac{\frac{{\partial }^{2} {T}_{m}}{\partial {t}^{2}}}{{( 1 + {( \frac{\partial {T}_{m}}{\partial t} )}^{2} )}^{3 / 2}} .$$

The measured temperature Tₘ(\vec{r}ₛₑₙₛ, t₁(\vec{r}ₛₑₙₛ)) is different from T_{free} since the wall is insulated in the period t₁−t₀ required for the temperature sensing element to approach the exterior wall surface temperature. When the insulated surface equilibrium temperature T_{surface}(\vec{r}ₛₑₙₛ) has been determined, the difference between Tₘ(\vec{r}ₛₑₙₛ, t₁(\vec{r}ₛₑₙₛ)) and T_{free} can be corrected for by extrapolation with an exponential function fitted to the measured temperature evolution since the time t₁.

It should be noted that the exterior wall surface of the pipe or vessel herein, to which the temperature determining apparatus is attached, throughout the description and the claims should be regarded as the part of the outer surface of the pipe or vessel that is covered by the thermally insulating body of the temperature determining apparatus when the temperature determining apparatus is attached to the pipe or vessel. The free exterior wall surface, also referred to as the free surface, should be regarded herein, throughout the description and the claims, as the outer wall surface of the pipe or vessel that is not covered by the thermally insulating body of the temperature determining apparatus and is without insulation.

Thus, there is provided a temperature determining apparatus for determining the temperature of fluids contained in a pipe or vessel having an exterior wall surface, the temperature determining apparatus comprising at least one temperature sensing element which is signally connected to a control unit for reading and processing signals received from the at least one temperature sensing element. The temperature determining apparatus further comprises an attachment device for attachment/mounting of the temperature determining apparatus to the exterior wall surface of the pipe or vessel. The temperature determining apparatus also comprises a thermally insulating body which is adapted to be in contact with the exterior wall surface of the pipe or vessel when the temperature determining apparatus is attached/mounted to the pipe or vessel. At least one temperature sensing element is arranged such that it is capable of sensing the temperature T_{surface} of the exterior wall surface covered by the thermally insulating body when the temperature determining apparatus is attached/mounted to the exterior wall surface of the pipe or vessel. And at least one second temperature sensing element is arranged such that it is capable of sensing the ambient temperature T_{amb} of the medium surrounding the pipe or vessel (14). The temperature determining apparatus further comprises at least one third temperature sensing element which is arranged to sense the free skin temperature T_{free} of the free exterior wall surface of the pipe or vessel. A temperature T_{fluid} of the fluid contained in the pipe or vessel (14) is determined by

$${τ}_{f l u i d} = k ( \vec{r} ) {T}_{surface} ( \vec{r} ) - ( k ( \vec{r} ) - 1 ) {T}_{a m b} ,$$

wherein \vec{r} is a position at the exterior wall surface (15) where the said at least one first temperature sensing element (28) is arranged and k(\vec{r}) is calculated numerically from the three-dimensional geometry of the temperature determining apparatus and the wall of the pipe or vessel, given knowledge of the thermal conductivities of the wall material and the material of the thermally insulating body (22). And wherein the thermal conductance of the wall of the pipe or vessel (14) can be estimated by combining knowledge of T_{amb}, T_{surface}, and T_{free}.

The apparatus is preferably mechanically designed to expel the medium surrounding the pipe or vessel from the area where the thermally insulating body is in contact with the exterior wall surface. For example, the thermally insulating body may be provided with a contact surface that is adapted to expel the medium between the contact surface of the thermally insulating body and the exterior wall surface of the pipe or the vessel as the temperature determining apparatus is attached/mounted to the pipe or vessel.

The contact surface of thermally insulating body is provided with a contact surface curvature and the exterior wall surface of the pipe or vessel is provided with an exterior wall curvature. The contact surface curvature is preferably larger than the exterior wall curvature such that a gap forms between the thermally insulating body and the exterior wall surface, and the thermally insulating body is preferably sufficiently elastic, or may comprise moving parts, so that the thermally insulating body is adaptable to an exterior wall curvature of a pipe or vessel with a smaller radius of curvature than the contact surface curvature and is adapted to eliminate a gap when the temperature determining apparatus is attached/mounted to a pipe or vessel and the thermally insulating body is pressed against the exterior wall surface of the pipe or vessel.

In the process of eliminating the gap between the thermally insulating body and the exterior wall of the pipe or vessel, substantially all the medium, such as water and/or air, present in the gap is expelled. Thus, the contact surface of the thermally insulating body is tightly attached/mounted to the exterior wall surface and thereby expelling the medium between the thermally insulating body and the exterior wall surface when the temperature measuring apparatus is attached/mounted to the exterior wall surface.

The contact surface may be provided with one or more groves to enable the medium, such as water and/or air, to escape from gap between the thermally insulating body and the exterior wall surface of the pipe or vessel through the groove(s) as the temperature determining apparatus is attached/mounted to the pipe or vessel.

The contact surface may be adapted to the shape of a section of the exterior wall surface to which the temperature measuring apparatus is adapted to be attached/mounted.

The at least one temperature sensing element is preferably arranged at the contact surface of the thermally insulating body so that it is in thermal contact with the exterior wall surface of the pipe or vessel when the temperature determining apparatus is attached/mounted to the pipe or vessel.

The at least one temperature sensing element preferably comprises a temperature sensing surface which is in thermal contact with the exterior wall surface of the pipe or vessel when the temperature determining apparatus is attached/mounted to the pipe or vessel.

The at least one temperature sensing element which measures the temperature of the external wall surface, is preferably covered by the thermally insulating body towards the surrounding medium when the temperature determining apparatus is attached/mounted to the pipe or vessel.

The at least one temperature sensing element may be mounted in the thermally insulating body, for example in a cavity adapted to receive the at least one temperature sensing element, so that it is in thermal contact with the exterior wall surface of the pipe or vessel when the temperature determining apparatus is attached/mounted to the pipe or vessel, and thereby is capable of sensing the temperature of the exterior wall surface of the pipe or vessel.

The temperature determining apparatus preferably comprises at least one first temperature sensing element which is arranged such that it is capable of sensing the temperature of the exterior wall surface of the pipe or vessel, and at least one second temperature sensing element which is capable of sensing the temperature of the surrounding medium, where the at least one first temperature sensing element and the at least one second temperature sensing element are signally connected to the control unit.

The at least one first temperature sensing element may be mounted in the thermally insulating body, for example in a cavity adapted to receive the at least one first temperature sensing element, so that it is in thermal contact with the exterior wall surface of the pipe or vessel when the temperature determining apparatus is attached/mounted to the pipe or vessel, and thereby is capable of sensing the temperature of the exterior wall surface of the pipe or vessel.

The at least one second temperature sensing element is arranged in a cavity or a surface of the thermally insulating body such that it is capable of sensing the temperature of the surrounding medium when the temperature determining apparatus is attached/mounted to the pipe or vessel. The at least one second temperature sensing element may, for example, be mounted in a cavity in the thermally insulating body adapted to receive the at least one second temperature sensing element, so that it is in thermal contact with the medium surrounding the pipe or vessel when the temperature determining apparatus is attached/mounted to the pipe or vessel, and thereby being capable of sensing the temperature of the surrounding medium of the pipe or vessel.

The at least one first temperature sensing element is preferably arranged at a surface of the thermally insulating body so that the at least one first temperature sensing element is in thermal contact with the exterior wall surface of the pipe or vessel when the temperature determining apparatus is attached/mounted to the pipe or vessel.

The at least one second temperature sensing element is preferably arranged at a surface of the thermally insulating body so that the at least one second temperature sensing element is in thermal contact with the surrounding medium when the temperature determining apparatus is attached/mounted to the pipe or vessel.

The at least one first temperature sensing element preferably comprises a first temperature sensing surface which is in thermal contact with the exterior wall surface of the pipe or vessel when the temperature determining apparatus is attached to the pipe or vessel. The at least one second temperature sensing element preferably comprises a second temperature sensing surface which is in thermal contact with the surrounding medium when the temperature determining apparatus is attached/mounted to the pipe or vessel.

The at least one first temperature sensing element is preferably mounted in the thermally insulating body, for example in a cavity adapted to receive the at least one first temperature sensing element, so that it is in thermal contact with the exterior wall surface of the pipe or vessel when the temperature determining apparatus is attached/mounted to the pipe or vessel, whereby the at least one first temperature sensing element is capable of sensing the temperature of the exterior wall surface of the pipe or vessel.

The at least one second temperature sensing element is preferably mounted in the thermally insulating body, for example in a cavity adapted to receive the at least one second temperature sensing element, so that it is in thermal contact with the surrounding medium when the temperature determining apparatus is attached/mounted to the pipe or vessel, whereby the at least one second temperature sensing element is capable of sensing the temperature of the surrounding medium.

The temperature determining apparatus may further comprise at least one third temperature sensing element which is arranged to sense the temperature of the free exterior wall surface of the pipe or vessel, where the at least one third temperature sensing element is signally connected to the control unit.

The at least one third temperature sensing element is preferably arranged at least partly on the free exterior wall surface of the pipe or vessel.

The at least one third temperature sensing element preferably comprises a third temperature sensing surface which is in thermal contact with the free exterior wall surface of the pipe or vessel when the temperature determining apparatus is attached/mounted to the pipe or vessel.

The attachment device for attachment/mounting of the temperature determining apparatus to the pipe or vessel may comprise at least one magnet device and/or at least one clamping device and/or a suction device and/or an adhesive and/or any other suitable device that can be used for attachment/mounting of the temperature determining apparatus to the pipe or vessel.

The thermally insulating body preferably comprises an elastic or rigid syntactic foam, such as, for example, epoxy, polyurethane or silicon.

The temperature determining apparatus may comprise at least one holding device for attachment of an underwater vehicle such that the temperature determining apparatus can be handled by the underwater vehicle. Thus, the temperature determining apparatus can be affixed to the pipe or vessel, and later removed, by the underwater vehicle. The underwater vehicle may be a remote operated or autonomous underwater vehicle.

The temperature determining apparatus may be designed for repeated attachment/mounting and detachment/demounting to enable short-term monitoring or inspection of fluid temperature at multiple locations. This will provide the temperature determining apparatus with the ability for repeated attachments/mounting and detachments/demounting allows short-term monitoring or inspection of fluid temperature on demand and/or at multiple locations in sequence.

Alternatively, the temperature determining apparatus may be designed for permanent attachment/mounting to the pipe or vessel at a fixed location.

The at least one temperature sensing element, i.e., the at least one first temperature sensing element and/or the at least one second temperature sensing element and/or the at least one third temperature sensing element, may be connected to the control unit with at least one signal cable.

Alternatively, the at least one temperature sensing element, i.e., the at least one first temperature sensing element and/or the at least one second temperature sensing element and/or the at least one third temperature sensing element, may be connected to the control unit with wireless communication, such as for example wi-fi and/or Bluetooth and/or underwater acoustic communication.

The temperature determining apparatus further preferably comprises a mechanical structure, such as a housing, which holds the components of the temperature determining apparatus in place. The mechanical structure can be attached/mounted to the wall surface of the pipe or vessel by magnets and/or clamps and/or adhesion and/or suction and/or other suitable attachment or mounting means.

The medium surrounding the pipe or vessel will usually be water, seawater or air.

There is also provided a method for determining the temperature of fluids contained in a pipe or vessel surrounded by a medium, wherein the method comprises the following steps:
Providing a temperature determining apparatus comprising at least two temperature sensing elements and a thermally insulating body which is adapted to be arranged on an exterior wall surface of the pipe or vessel, wherein at least one temperature sensing element is arranged such that it is capable of measuring the temperature of the exterior wall surface of the pipe or vessel when the temperature determining apparatus is attached/mounted to the pipe or vessel, and wherein at least one second temperature sensing element is arranged such that it is capable of sensing the ambient temperature of the medium surrounding the pipe or vessel,
Attaching/mounting the temperature determining apparatus to the exterior wall surface of the pipe or vessel such that the thermally insulating body is in contact with the exterior wall surface,
letting the at least one temperature sensing element measure the temperature of the exterior wall surface of the pipe or vessel,
transferring measured temperature data to a control unit of the temperature determining apparatus and letting the control unit process the temperature data.

The method further preferably includes a step where the at least one first temperature sensing element, the at least one second temperature sensing element, and the thermally insulating body are brought in contact with the exterior wall surface of the pipe or vessel when the temperature determining apparatus is attached/mounted to the exterior wall surface, where the thermally insulating body covers the at least one first temperature sensing element so that the measured temperature is similar to the temperature of the exterior wall surface.

The method further preferably includes a step where the medium surrounding the pipe or vessel is expelled from the area where the thermally insulating body is in contact with the exterior wall surface of the pipe or vessel, when the temperature determining apparatus is attached/mounted to the pipe or vessel.

The temperature determining apparatus comprises at least one first temperature sensing element and at least one second temperature sensing element. Thus, the method preferably includes a step where the temperature of the exterior wall surface is measured by the at least one first temperature sensing element and the temperature of the surrounding medium is measured by the at least one second temperature sensing element.

The method further preferably includes a step where the measured temperature data are transferred from the at least one first temperature sensing element and the at least one second temperature sensing element to a control unit of the temperature determining apparatus where the temperature data are processed. Both the at least one first temperature sensing element and the at least one second temperature sensing element may be connected to the control unit with respective signal cables or with wireless communication, such as for example wi-fi and/or Bluetooth and/or underwater acoustic communication.

The method further preferably includes a step where the temperature of the fluid inside the pipe or the vessel is estimated by using the measured temperature of the exterior wall surface measured by the at least one first temperature sensing element and the measured temperature of the surrounding medium measured by the at least one second temperature sensing element.

The temperature determining apparatus may also comprise at least one third temperature sensing element, Thus, the method may also include a step where the temperature of the free exterior wall surface is measured by the at least one third temperature sensing element and is used to estimate the thermal conductance of the wall of the pipe or vessel.

The at least one third temperature sensing element is preferably also signally connected to the control unit. The at least one third temperature sensing element may be connected to the control unit with respective signal cables or with wireless communication, such as for example wi-fi and/or Bluetooth and/or underwater acoustic communication.

The method further preferably includes a step wherein the thermal conductance of the wall of the pipe or vessel is estimated by using temperature measured by at least one third temperature sensing element which measures the temperature of the free exterior wall surface.

The method further preferably includes a step wherein the temperature of the fluid in the pipe or vessel is estimated by using the temperature measured by the at least one first temperature sensing element which measures the temperature of the exterior wall surface of the pipe or vessel under (i.e., covered by) the thermally insulating body when the temperature determining apparatus is attached/mounted to the pipe or vessel, and by analysis of the time evolution of the measured temperature as the apparatus is being attached/mounted to the wall surface.

The method further preferably includes a step wherein the control unit processes the temperature data received from the at least one first temperature sensing element and/or the at least one second temperature sensing element and/or the at least one third temperature sensing element. Thus, the control unit may convert the temperature data to digital data, optionally storing the said data, and optionally transmitting the said data to a client system.

The method described herein may be used for short-term monitoring or inspection of fluid temperature of the fluid in the pipe or vessel at a single or a multiple of locations. The method described herein may also be used for permanent monitoring of fluid temperature at one or more fixed locations on the pipe or vessel.

### BRIEF DESCRIPTION OF THE FIGURES

Some non-limiting embodiments of the present invention will now be described, by way of examples, with reference to the following figures wherein:

FIG. 1a-b illustrates an embodiment of a temperature determining apparatus according to the present invention where the temperature determining apparatus is attached to a pipe.

FIG. 2 shows an illustration of a section through an embodiment of the temperature determining apparatus comprising a first temperature sensing element which senses the temperature of the exterior wall surface of the pipe and is covered by the thermally insulating body.

FIG. 3 shows an illustration of a section through an embodiment of the temperature determining apparatus comprising a first temperature sensing element which senses the temperature of the exterior wall surface of the pipe and a second temperature sensing element which senses the temperature of the surrounding medium.

FIG. 4 shows an illustration of a section through an embodiment of the temperature determining apparatus comprising two first temperature sensing elements both sensing the temperature of the exterior wall surface of the pipe, and a second temperature sensing element which senses the temperature of the surrounding medium.

FIG. 5 shows an illustration of a section through an embodiment of the temperature determining apparatus comprising a first temperature sensing element which senses the temperature of the exterior wall surface of the pipe, a second temperature sensing element which senses the temperature of the surrounding medium, and a third temperature sensing element which senses the temperature of the free exterior wall surface of the pipe.

FIG. 6a-6b illustrates the temperature determining apparatus before the temperature determining apparatus is attached to the pipe where there is a gap between the thermally insulating body of the temperature determining apparatus and the pipe, and after the temperature determining apparatus has been attached to the pipe where the gap has been eliminated to expel the medium that was initially present in the gap.

FIG. 7 illustrates with a full-drawn curve the evolution with time of a temperature Tₘ(t) measured by a sensing element positioned in the temperature determining apparatus.

FIG. 8 illustrates the curvature γ(t) of the measured temperature function Tₘ(t) illustrated in FIG. 7.

### DETAILED DESCRIPTION OF THE FIGURES

Firstly, it should be mentioned again that the exterior wall surface of the pipe or vessel, also throughout the description of the figures, should be regarded as the part of the outer surface of the pipe or vessel that is covered by the thermally insulating body of the temperature determining apparatus when the temperature determining apparatus is attached to the pipe or vessel. The free exterior wall surface, also referred to as the free surface, should be regarded, throughout the description of the figures, as the outer wall surface of the pipe or vessel that is without insulation and is not covered by the thermally insulating body of the temperature determining apparatus when the temperature determining apparatus is attached to the pipe or vessel.

It should also be mentioned that each feature of the temperature determining apparatus 10 and the pipe or vessel 14 that is shown in the figures, have been given the same reference number in all figures in which it is shown.

The embodiments of the temperature determining apparatus 10 according to the present invention, which are illustrated in the figures, are shown attached to a pipe 14. As indicated above, the temperature determining apparatus 10 is also suitable for determining the temperature of fluids contained in a vessel, tank or any similar container in which a fluid is contained. When the term “pipe” is used in the description of the figures, it should therefore be understood that it could be any other suitable type of vessel containing a fluid.

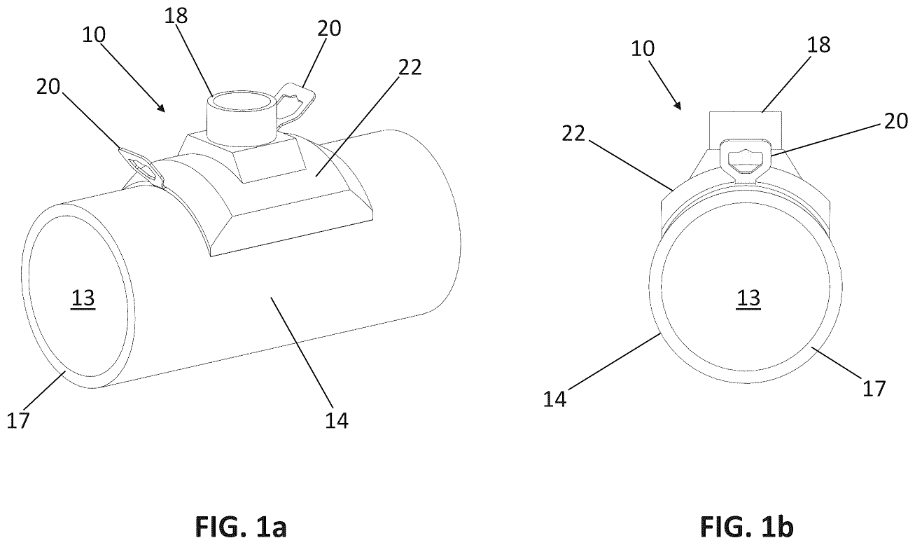

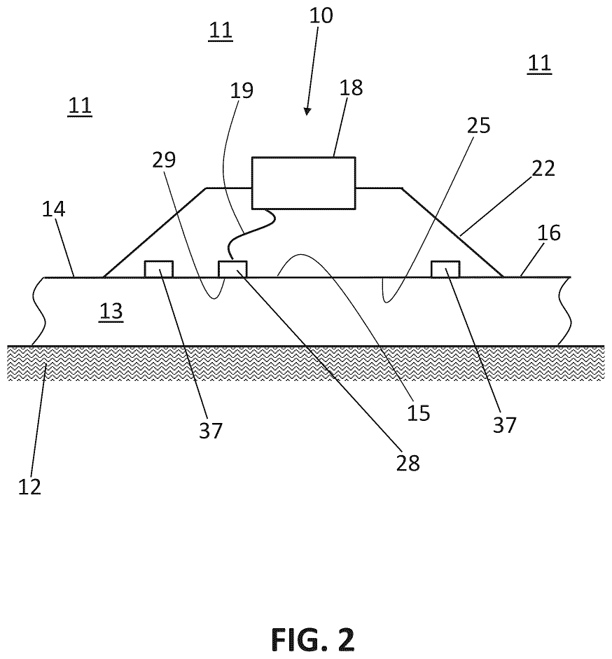

FIGS. 1a-1b illustrates a temperature determining apparatus 10 according to the present invention, where the temperature determining apparatus 10 is attached to a pipe 14. The pipe 14 comprises a pipe wall 17 and contains a fluid 13 as indicated in FIG. 1a. The temperature determining apparatus 10 is affixed on the exterior wall surface 15 (see FIGS. 2-5). The temperature determining apparatus 10 comprises a thermally insulating body 22 which is attached to the pipe 14 such that it covers an exterior wall surface 15 of the pipe 14. The temperature determining apparatus 10 also comprises control unit 18 for processing data received from one or more temperature sensing elements 28, 31, 34. The temperature determining apparatus 10 further comprises one or more holding devices 20 for manipulation the temperature determining apparatus 10, for example, by using a remote underwater vehicle (ROV), When the ROV has gripped the holding device 20, the temperature determining apparatus 10 can be held and moved around, attached to the pipe 14 and detached from the pipe 14.

FIGS. 2-5 shows some possible variants of a temperature determining apparatus 10 with different arrangements of one or more temperature sensing elements 28, 31, 34. The pipe 14 has a pipe wall 17 on which a thermally insulating body 22 of the temperature determining apparatus 10 is attached. The pipe 14 contains a fluid 13 having a temperature which the temperature determining apparatus 10 is designed to determine without physically drilling a hole in the pipe wall 17 or making any other similar physical intervention in order to enable a temperature sensing element to be physically in contact with the fluid 13 to measure the temperature directly. As further shown in FIGS. 2-5, the temperature determining apparatus 10 is provided with a control unit 18 which is signally connected to all temperature sensing elements 28, 31, 34 of the temperature determining apparatus 10.

As further indicated in FIGS. 2-5, the temperature determining apparatus 10 comprises one or more attachment devices 37 for attachment or mounting of the temperature determining apparatus 10 to the pipe 14 and possible detachment of the temperature determining apparatus 10 from the pipe 14. The attachment device(s) 37 for attachment/mounting of the temperature determining apparatus 10 to the pipe 14 may comprise at least one magnet device, at least one clamping device, a suction device, an adhesive or any other suitable attachment device 37 that can be used for attachment/mounting of the temperature determining apparatus 10 to the pipe 14. A combination of one or more of the various types of attachment devices 37 may of course also be used for attachment/mounting of the temperature determining apparatus 10 to the pipe 14.

As indicated in FIGS. 2-5, the temperature determining apparatus 10 may be provided with at least one temperature sensing element 28, 31, 34.

In FIG. 2, the temperature determining apparatus 10 is shown being provided with a first temperature sensing element 28 which is arranged so that it is capable of sensing the temperature of the exterior wall surface 15 of the pipe 14. The first temperature sensing element 28 is covered by the thermally insulating body 22 of the temperature determining apparatus 10 and is signally connected to the control unit 18 such that the temperature data obtained by the first temperature sensing element 28 can be transferred to the control unit 18 for further processing.

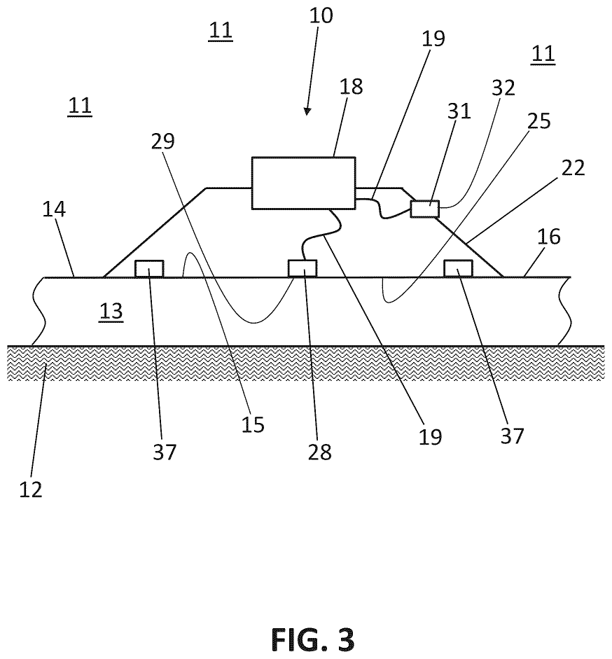

In FIG. 3, the temperature determining apparatus 10 is shown being provided with a first temperature sensing element 28 which is arranged so that it is capable of sensing the temperature of the exterior wall surface 15 of the pipe 14, and a second temperature sensing element 31 which is arranged so that it is capable of sensing the temperature of the surrounding medium 11 that surrounds the pipe 14 and the temperature determining apparatus 10. The first temperature sensing element 28 is covered by the thermally insulating body 22 of the temperature determining apparatus 10 while the second temperature sensing element 31 is at least in part directly exposed to the surrounding medium 11. The first temperature sensing element 28 and the second temperature sensing element 31 are both signally connected to the control unit 18 such that the temperature data obtained by the first temperature sensing element 28 and the second temperature sensing element 31 can be transferred to the control unit 18 for further processing.

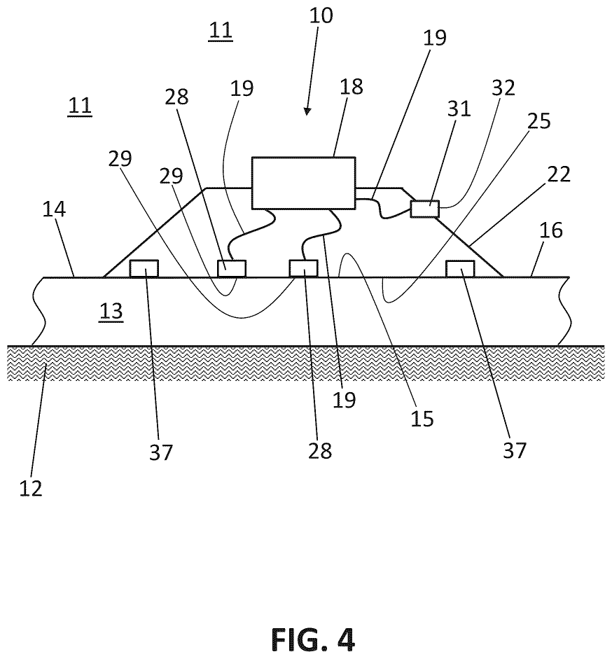

In FIG. 4, the temperature determining apparatus 10 is shown being provided with two first temperature sensing elements 28 which are arranged so that they are capable of sensing the temperature of the exterior wall surface 15 of the pipe 14, and a second temperature sensing element 31 which is arranged so that it is capable of sensing the temperature of the surrounding medium 11 that surrounds the pipe 14 and the temperature determining apparatus 10. The first temperature sensing elements 28 are both covered by the thermally insulating body 22 of the temperature determining apparatus 10 while the second temperature sensing element 31 is at least in part directly exposed to the surrounding medium 11. The first temperature sensing elements 28 and the second temperature sensing element 31 are all signally connected to the control unit 18 such that the temperature data obtained by the first temperature sensing elements 28 and the second temperature sensing element 31 can be transferred to the control unit 18 for further processing.

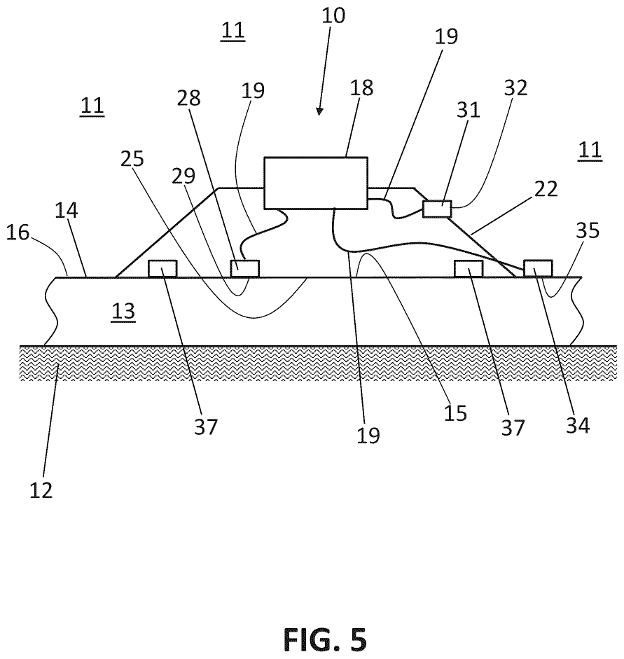

In FIG. 5, the temperature determining apparatus 10 is shown being provided with a first temperature sensing element 28 which is arranged so that it is capable of sensing the temperature of the exterior wall surface 15 of the pipe 14, a second temperature sensing element 31 which is arranged so that it is capable of sensing the temperature of the surrounding medium 11 that surrounds the pipe 14 and the temperature determining apparatus 10, and a third temperature sensing element 34 which is arranged so that it is capable of sensing the temperature of the free exterior wall surface 16 of the pipe 14. The first temperature sensing element 28 is covered by the thermally insulating body 22 of the temperature determining apparatus 10. The second temperature sensing element 31 is at least in part directly exposed to the surrounding medium 11. The third temperature sensing element 34 is attached/mounted to the pipe 14 and arranged so that at least a part of, but preferably the entire third temperature sensing element 34 is located outside the thermally insulating body 22. The first temperature sensing element 28, the second temperature sensing element 31 and the third temperature sensing element 34 are all signally connected to the control unit 18 such that the temperature data obtained by the first temperature sensing element 28, the second temperature sensing element 31 and the third temperature sensing element 34 can be transferred to the control unit 18 for further processing.

The temperature determining apparatus 10 is provided with one or more first temperature sensing element(s) 28 in all embodiments shown in the figures. The first temperature sensing element(s) is/are provided with a first temperature sensing surface 29 which is capable of sensing the temperature of the exterior wall surface 15 of the pipe wall 17. The first temperature sensing element(s) 28 can be arranged in respective cavities in a contact surface 25 of the thermally insulating body 22 such that the first temperature sensing surface(s) 29 is in thermal contact with the exterior wall surface 15 of the pipe wall 17 when the temperature determining apparatus 10 is attached/mounted to the pipe 14. Thus, the contact surface 25 of the thermally insulating body 22 is the outer surface of the thermally insulating body 22 that faces the pipe 14 and is pressed against the temperature determining apparatus 10 when the temperature determining apparatus 10 is attached/mounted to the pipe 14. At the same time, the thermally insulating body 22 covers the first temperature sensing element(s) 29 and prevents the surrounding medium 11 from affecting the results of the temperature sensing of the first temperature sensing element(s).

The embodiments of the temperature determining apparatus 10 shown in FIGS. 3-5 are provided with one second temperature sensing element 31 only, but a plurality of second temperature sensing element(s) 31 may of course be included in the various embodiments shown in the figures. The second temperature sensing element(s) is/are provided with a second temperature sensing surface 32 which is capable of sensing the temperature of the surrounding medium 11 that surrounds the pipe 14 and the temperature determining apparatus 10 when the temperature determining apparatus is attached/mounted to the pipe 14. The second temperature sensing element(s) 32 can be arranged in one or more cavities of the thermally insulating body 22 facing the surrounding medium 11 such that the second temperature sensing surface(s) 32 is/are in thermal contact with the surrounding medium 11 when the temperature determining apparatus 10 is attached/mounted to the pipe 14.

The third temperature sensing element 34 shown in FIG. 5 is provided with a third temperature sensing surface 35 which is capable of sensing the temperature of the free exterior wall surface 16 of the pipe wall 17 when the temperature determining apparatus is attached/mounted to the pipe 14.

The embodiments of the temperature determining apparatus 10 shown in FIG. 5 is provided with one third temperature sensing element 34 only, but a plurality of third temperature sensing element(s) 34 may of course be included in the embodiment shown in the figures. The third temperature sensing element(s) is/are provided with a third temperature sensing surface 35 which is capable of sensing the temperature of the free exterior wall surface 16 of the pipe wall 17 of the pipe 14 when the temperature determining apparatus 10 is attached/mounted to the pipe 14. The third temperature sensing element 34 may be attached/mounted to the free exterior wall surface 16 with at least one magnet device, at least one clamping device, a suction device, an adhesive or any other suitable attachment device that can be used for attachment/mounting of the third temperature sensing element 34 to the free exterior wall surface 16. As already mentioned, the free exterior surface 16 of the pipe wall 17 can be regarded as the outer wall surface of the pipe 10 that is not covered by the thermally insulating body 22 of the temperature determining apparatus 10 and is without insulation.

The first temperature sensing element(s) 28, the second temperature sensing element(s) 31 and the third temperature sensing element(s) 34 are all signally connected to the control unit 18. The first temperature sensing element(s) 28, the second temperature sensing element(s) 31 and the third temperature sensing element(s) 34 can be signally connected to the control unit 18 with signal cables or wireless communication, such as, for example, wi-fi and/or Bluetooth and/or underwater acoustic communication, or with a combination of signal cable(s) and wireless communication.

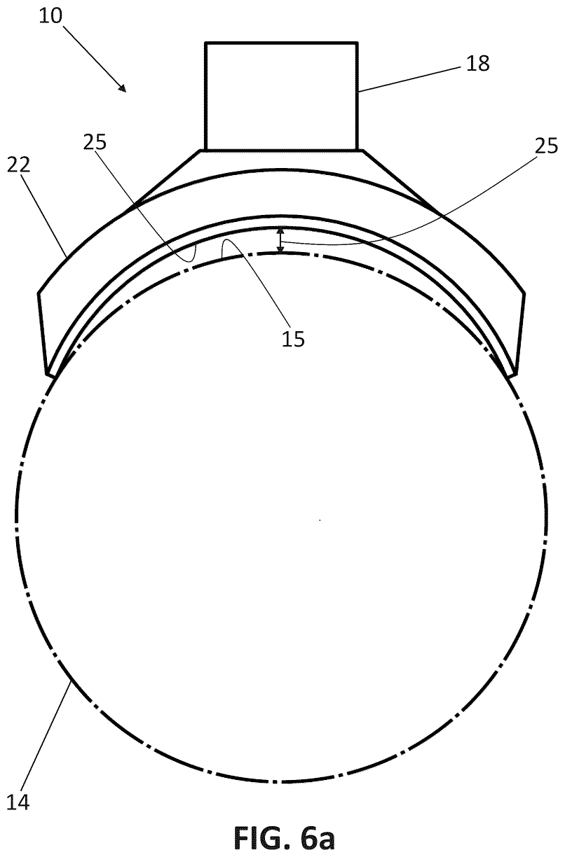

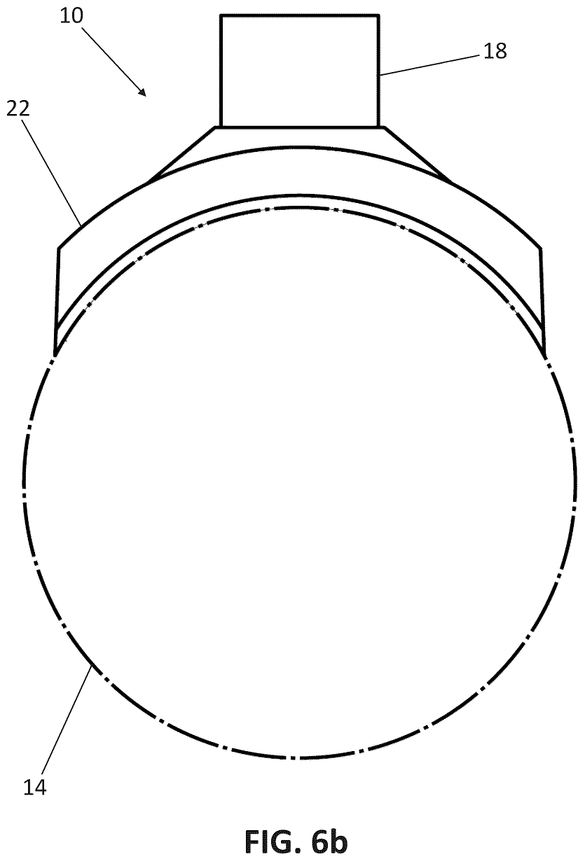

FIGS. 6a-6b illustrate the temperature determining apparatus 10 including the thermally insulating body 22 and the control unit 18, wherein the thermally insulating body 22 is shaped or designed in such a way that it expels water from the exterior wall surface 15 of the pipe 14 covered by the thermally insulating body 22 while it is being attached/mounted to the pipe 14.

For example, the contact surface 25 of the thermally insulating body 22 can be provided with a contact surface curvature that is somewhat larger than the curvature of the exterior wall surface 15 such that a gap 26 (see FIG. 6a) forms between the thermally insulating body 22 and the exterior wall surface 15 before the temperature determining apparatus 10, and thereby the thermally insulating body 22, is pressed against the pipe wall 17 of the pipe 14 and is securely attached/mounted to the pipe 14. The thermally insulating body 22 is sufficiently elastic, or the thermally insulating body 22 may comprise moving parts, such that the shape of the thermally insulating body 22, and therefore the shape of the contact surface 25, adapts to the curvature of the exterior wall surface 15 and eliminates said gap 26 (see FIG. 6b) as the temperature determining apparatus 10 is attached/mounted to/mounted on the pipe 14 and the thermally insulating body 22 is pressed against the exterior wall surface 15 of the pipe 14. In the process of pressing the thermally insulating body 22 against the pipe wall 17 and eliminating the gap 26 between the thermally insulating body 22 and the exterior wall surface 15 of the pipe wall 17, any medium present in the gap 26, such as water, is expelled. Thus, the contact surface 25 of the thermally insulating body 22 is tightly attached/mounted to the exterior wall surface 15 and the medium 11 that was present between the thermally insulating body 22 and the exterior wall surface 15 when the temperature measuring apparatus 10 is attached/mounted to the exterior wall surface, is expelled.

As already mentioned, the thermally insulating body 22 may comprise an elastic or rigid syntactic foam, such as, for example, epoxy, polyurethane or silicon.

Thus, the illustrations in FIGS. 1-6 include subsets of the components that comprise a temperature determining apparatus 10 embodying the present invention. At least, such a temperature determining apparatus comprises at least one, but preferably a plurality of temperature sensing elements 28, 31, 24, a thermally insulating body 22, interrogating electronic circuitry, such as a control unit 18, that reads the temperatures measured by the at least one temperature sensing element 28, 31, 34, transforms them to digital information, and processes and stores the digital information. The temperature determining apparatus 10 may also include an optional digital communication interface for delivering the temperature measurement results to a client system. The temperature determining apparatus 10 further comprises a mechanical structure or housing that holds all the components in place and attaches to the surface of the pipe wall 17 by magnets, clamps, adhesion, suction, or other suitable means. The temperature determining apparatus 10 mechanical arrangement, such as a holding device 20, for holding the temperature determining apparatus 10 when it is not attached/mounted to the pipe 10, attaching/mounting it to the pipe wall 17, and detaching it therefrom. In embodiments for use underwater, the said mechanical holding device 20 can be designed to be operated by means of a remote underwater vehicle (ROV) and the buoyancy of the temperature determining apparatus 10 in seawater can be made close to its mass so that its weight in seawater is close to zero.

The temperature sensing element(s) 28 is/are placed in close contact with the exterior wall surface 15 of the pipe wall 17. The thermally insulating body 22 covers the temperature sensing element(s) 28 in contact with the exterior wall surface 15. The other temperature sensing elements, i.e. the second temperature sensing element(s) 31 and the third temperature sensing element(s) 34, measure the temperature in the surrounding medium 11 (atmosphere, fresh water or seawater) and the free exterior wall surface temperature of the pipe wall 17 respectively.

The thermally insulating body 22 and mechanical structure included in the temperature determining apparatus 10 should be designed in such a way that the surrounding medium is expelled from the contact surface between the exterior wall surface 15 and the thermally insulating body 22 when the temperature determining apparatus 10 is affixed to the pipe 14. Fluid inclusions or even flow in the contact area can cause great difference between the measurement situation and the theoretical model and design tests performed for the temperature determining apparatus 10 according to the invention. Accurate estimates of internal fluid temperature are only achieved if all mechanisms of thermal energy transfer are under strict control. As described above, FIGS. 6a-6b illustrates one example of an embodiment, where the temperature determining apparatus 10 is shaped with a smaller radius of curvature than the outer surface of the pipe wall 14 on which it is attached or mounted. Upon installation the thermal insulation of the thermally insulating body 22 is deformed, channels (not shown in the figures) remain for the surrounding medium 11 to flow away from the contact surface, and mechanical tension in the temperature determining apparatus 10 holds the surface of the pipe wall 17 and of the contact surface 25 of the thermally insulating body 22 in contact throughout the designed contact area while the temperature determining apparatus 10 is attached/mounted.

In another embodiment, where the temperature determining apparatus 10 includes a clamping arrangement for installation on the pipe 14, the thermally insulating body 22 has a greater radius of curvature than the pipe, and the clamping mechanism forces the insulating body onto the wall surface throughout the intended contact area between the thermally insulating body 22 and the pipe wall 17, i.e. the exterior wall surface 15. Also, in this said other embodiment, the shape of the temperature determining apparatus 10 allows the surrounding medium 11 to flow out of the contact area when the temperature determining apparatus 10 is being attached/mounted to the wall.

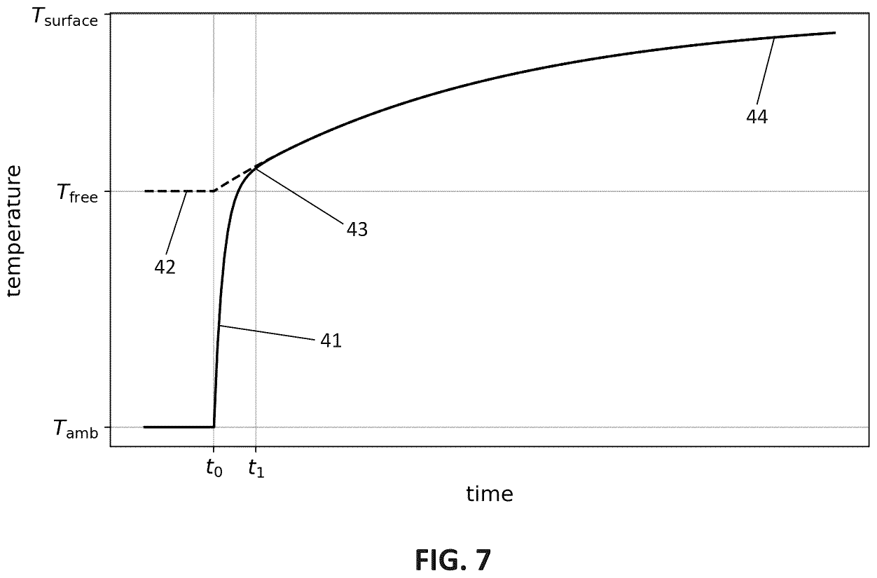

FIG. 7 illustrates, with a full-drawn curve, the evolution with time of a temperature Tₘ(t) measured by a temperature sensing element 28 arranged in such a way that it will sense the temperature of the pipe wall 17 at the contact surface between the exterior wall surface 15 and the thermally insulating body 22 when the temperature determining apparatus 10 is attached/mounted to the pipe 14. The dashed curve 42 illustrates the temperature at the exterior wall surface 15, in the point where a temperature sensing element 28 will come in thermal contact with the pipe wall 17. Before the time t₀ when the temperature determining apparatus 10 is attached/mounted to the surface of the pipe wall 17, Tₘ is equal to the temperature of the surroundings, T_{amb}, and the temperature at the exterior wall surface is T_{free}. The attachment/mounting of the temperature determining apparatus 10 causes both the measured temperature and the temperature of the surface of the pipe wall 17 to change towards the equilibrium temperature T_{surface}. The temperature sensing element 28 has significantly lower heat capacity than the material of the pipe wall 17 and thus changes temperature more quickly than the pipe 14. The measured temperature Tₘ(t) thus first changes quickly 41 to the wall surface temperature, before it changes more slowly 44 together with the exterior wall surface to the equilibrium temperature T_{surface}.

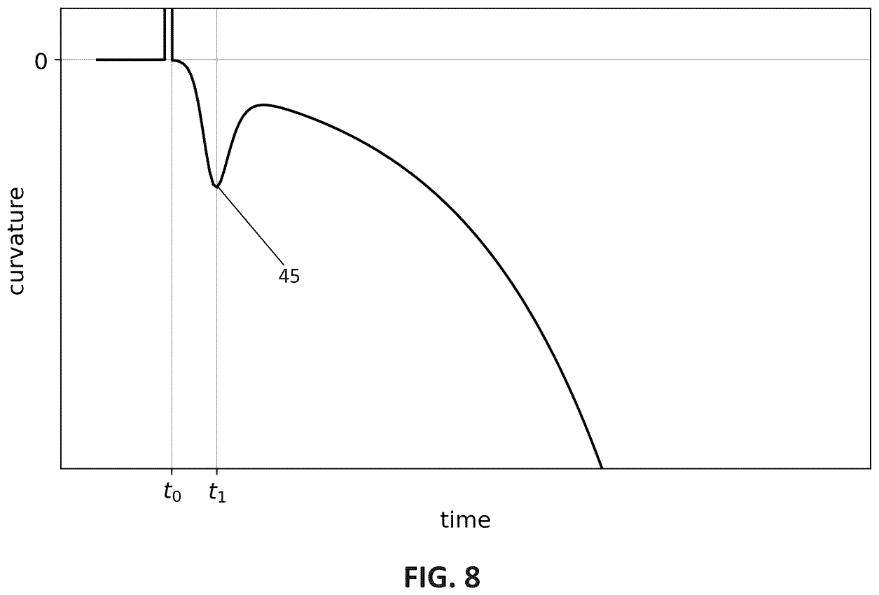

FIG. 8 illustrates the curvature γ(t) of the measured temperature function Tₘ(t) illustrated in FIG. 4. The time t₁ of transition 43 between an initial rapid change 41 from T_{amb} to the wall surface temperature and a following slower change 44 together with the wall surface temperature towards equilibrium is detectable as a local extremal point 45 in the curvature as shown in FIG. 8.

### REFERENCE NUMBERS USED IN THE FIGURES

| | |
|---|---|
| 10 | Temperature determining apparatus |
| 11 | Surrounding medium (for example water or air surrounding the pipe or vessel) |
| 12 | Seabed |
| 13 | Fluid (in the pipe or vessel) |
| 14 | Pipe or vessel |
| 15 | Exterior wall surface (of pipe or vessel) |
| 16 | Free exterior wall surface (of pipe or vessel) |
| 17 | Pipe wall (of the pipe or vessel) |
| 18 | Control unit (comprising electronics to convert and process signals from |
| | temperature sensing element) |
| 19 | Signal cable (extending between temperature sensing element and control unit) |
| 20 | Holding device (for ROV in order to manipulate the temperature determining |
| | apparatus (for example move it around and attach/detach it to/from the pipe or |
| | vessel) |
| 22 | Thermally insulating body |
| 23 | Upper part (of thermally insulating body) |
| 25 | Contact surface (surface of the thermally insulating body that contacts the |
| | exterior surface of vessel/pipe) |
| 26 | Gap (between thermally insulating body and exterior wall surface before the |
| | temperature determining apparatus is attached to, and the thermally insulating |
| | body pressed against, the exterior wall surface) |
| 28 | First temperature sensing element (temperature sensing element for reading |
| | temperature of exterior wall of pipe or vessel) |
| 29 | First temperature sensing surface (the part of the first temperature sensing |
| | element designed to sense the temperature of the exterior surface of pipe or |
| | vessel) |
| 31 | Second temperature sensing element (temperature sensing element for reading |
| | temperature of the surrounding medium, for example water) |
| 32 | Second temperature sensing surface (the part of the second temperature sensing |
| | element designed to sense the temperature of the surrounding medium, for |
| | example water) |
| 34 | Third temperature sensing element (temperature sensing element for reading |
| | temperature of the free exterior wall surface (i.e., outside the thermally insulated |
| | body)) |
| 35 | Third temperature sensing surface (the part of the third temperature sensing |
| | element designed to sense the temperature of the free exterior wall surface (i.e., |
| | outside the thermally insulated body)) |
| 37 | Attachment device (for attachment of the temperature determining apparatus to |
| | the pipe or vessel - for example magnetic elements) |
| 41 | Rapid change of temperature (as indicated by the graph between t₀ and t₁ in |
| | FIG. 7) |
| 42 | Temperature at the exterior wall surface where the at least one temperature |
| | sensing element is in thermal contact with the exterior wall surface. |
| 43 | Time t₁ of the transition between initial rapid change 41 to a slower change 44 |
| 44 | Temperature of exterior wall surface (as measured by the at least one first |
| | temperature sensing element)18 |
| 45 | Local extremal point at t₁ |

1. A temperature determining apparatus for determining the temperature of fluids contained in a pipe or vessel having an exterior wall surface, the temperature determining apparatus comprising at least two temperature sensing elements which are signally connected to a control unit for reading and processing signals received from the at least two temperature sensing elements, the temperature determining apparatus further comprising an attachment device for attachment or mounting of the temperature determining apparatus to the exterior wall surface of the pipe or vessel, wherein the temperature determining apparatus comprises a thermally insulating body which is adapted to be in contact with the exterior wall surface of the pipe or vessel when the temperature determining apparatus is attached or mounted to the pipe or vessel, and at least one first temperature sensing element is arranged such that it is capable of sensing the temperature of the exterior wall surface covered by the thermally insulating body when the temperature determining apparatus is attached or mounted to the exterior wall surface of the pipe or vessel, and at least one second temperature sensing element is arranged such that it is capable of sensing the ambient temperature T_{amb} of the medium surrounding the pipe or vessel, characterized in that the temperature determining apparatus further comprises at least one third temperature sensing element which is arranged to sense the free skin temperature T_{free} of the free exterior wall surface of the pipe or vessel,
wherein a temperature T_{fluid} of the fluid contained in the pipe or vessel (14) is determined by
$${T}_{fluid} = k ( \vec{r} ) {T}_{surface} ( \vec{r} ) - ( k ( \vec{r} ) - 1 ) {T}_{amb} ,$$
wherein \vec{r} is a position at the exterior wall surface (15) where the said at least one first temperature sensing element (28) is arranged and k(\vec{r}) is calculated numerically from the three-dimensional geometry of the temperature determining apparatus (10) and the wall of the pipe or vessel (14), given knowledge of the thermal conductivities of the wall material and the material of the thermally insulating body (22), and
wherein the thermal conductance of the wall of the pipe or vessel (14) can be estimated by combining knowledge of T_{amb}, T_{surface}, and T_{free}.

2. The temperature determining apparatus according to claim 1, wherein the temperature determining apparatus is mechanically designed to expel a medium surrounding the pipe or vessel from the area where the thermally insulating body is in contact with the exterior wall surface.

3. The temperature determining apparatus according to claim 1, wherein the thermally insulating body is provided with a contact surface that is adapted to expel the medium between the contact surface of the thermally insulating body and the exterior wall surface of the pipe or vessel as the temperature determining apparatus is attached or mounted to the pipe or vessel.

4. The temperature determining apparatus according to claim 1, wherein the contact surface of the thermally insulating body is provided with a contact surface curvature, and wherein the thermally insulating body is sufficiently elastic or comprises moving parts so that the thermally insulating body is adaptable to an exterior wall curvature of a pipe vessel with a smaller radius of curvature than the contact surface curvature and is adapted to eliminate a gap Between the contact surface and the exterior wall when the temperature determining apparatus is attached or mounted to a pipe or vessel and the thermally insulating body is pressed against the exterior wall surface of the pipe or vessel.

5. The temperature determining apparatus according to claim 1, wherein the at least one temperature sensing element (28, 31, 34) comprises a temperature sensing surface (29, 32, 35) which is in thermal contact with the exterior wall surface of the pipe or vessel when the temperature determining apparatus is attached or mounted to the pipe or vessel.

6. The temperature determining apparatus according to claim 1, wherein the at least one second temperature sensing element (31) is arranged in a cavity or a surface of the thermally insulating body (22) such that it is capable of sensing the temperature of the surrounding medium (11) when the temperature determining apparatus (10) is attached or mounted to the pipe or vessel (14).

7. (canceled)

8. The temperature determining apparatus according to claim 1, wherein the at least one third temperature sensing element is arranged at least partly on the free exterior wall surface of the pipe or vessel.

9. The temperature determining apparatus according to claim 1, wherein the attachment device for attachment or mounting of the temperature determining apparatus to the pipe or vessel comprises at least one magnet device and/or at least one clamping device and/or a suction device and/or an adhesive.

10. The temperature determining apparatus according to claim 1, wherein the temperature determining apparatus comprises at least one holding device for attachment or mounting of an underwater vehicle such that the temperature determining apparatus can be handled by the underwater vehicle.

11. The temperature determining apparatus according to claim 1, wherein the surrounding medium surrounding the pipe or vessel is water or air.

12. A method for determining the temperature of fluids contained in a pipe or vessel surrounded by a surrounding medium, wherein the method comprises the following steps:
providing a temperature determining apparatus comprising at least-ene first two temperature sensing elements and a thermally insulating body which is adapted to be arranged on an exterior wall surface (15) of the pipe or vessel, wherein at least one first temperature sensing element is arranged such that it is capable of measuring the temperature of the exterior wall surface of the pipe or vessel which is covered by the thermally insulating body when the temperature determining apparatus is attached or mounted to the pipe or vessel, and wherein at least one second temperature sensing element is arranged such that it is capable of sensing the ambient temperature T_{amb} of the medium surrounding the pipe or vessel,
attaching or mounting the temperature determining apparatus to the exterior wall surface of the pipe or vessel such that the thermally insulating body is in contact with the exterior wall surface,
letting the at least one temperature sensing element measure the temperature of the exterior wall surface of the pipe or vessel,
transferring measured temperature data to a control unit of the temperature determining apparatus and letting the control unit process the temperature data,
wherein a temperature T_{fluid} of the fluid contained in the pipe or vessel (14) is determined by
$${T}_{fluid} = k ( \vec{r} ) {T}_{surface} ( \vec{r} ) - ( k ( \vec{r} ) - 1 ) {T}_{amb} ,$$
wherein \vec{r} is a position at the exterior wall surface (15) where the said at least one first temperature sensing element (28) is arranged and k(\vec{r}) is calculated numerically from the three-dimensional geometry of the temperature determining apparatus (10) and the wall of the pipe or vessel (14), given knowledge of the thermal conductivities of the wall material and the material of the thermally insulating body (22),
wherein the temperature determining apparatus further comprises at least one third temperature sensing element, where the temperature of a free exterior wall surface of the pipe or vessel is measured by the at least one third temperature sensing element and is used to estimate the thermal conductance of the wall of the pipe or vessel.

13. The method according to claim 12,
wherein the at least one first temperature sensing element, the at least one second temperature sensing element, and the thermally insulating body are brought into contact with the exterior wall surface of the pipe or vessel when the temperature determining apparatus is attached or mounted to the exterior wall surface, the thermally insulating body covering the at least one first temperature sensing element so that the measured temperature is similar to the temperature of the exterior wall surface.

14. The method according to claim 12,
wherein the surrounding medium surrounding the pipe or vessel is expelled from the area where the thermally insulating body is in contact with the exterior wall surface of the pipe or vessel, when the temperature determining apparatus is attached or mounted to the pipe or vessel.

15. The method according to claim 12,
wherein the measured temperature data is transferred from the at least one first temperature sensing element and the at least one second temperature sensing element to a control unit of the temperature determining apparatus where the temperature data is processed.

16. (canceled)

17. The method according to claim 12,
wherein the thermal conductance of the wall of the pipe or vessel is estimated by using temperature measured by at least one third temperature sensing element which measures the temperature of the free exterior wall surface.

18. (canceled)

19. The method according to claim 12, wherein the temperature of the fluid in the pipe or vessel is estimated by using the temperature measured by the at least one first temperature sensing element which measures the temperature of the exterior wall surface of the pipe or vessel covered by the thermally insulating body when the temperature determining apparatus is attached or mounted to the pipe or vessel, and by analysis of the time evolution of the measured temperature as the temperature determining apparatus is being attached or mounted to the exterior wall surface.
